(19) United States
(12) Patent Application Publication
(10) Pub. No.: US 2022/0335100 A1
(43) Pub. Date: Oct. 20, 2022

(54) RECOMMENDED METHOD, CLIENT DEVICE AND SERVER FOR CHILDREN'S INDEPENDENT LEARNING

(71) Applicant: BEIJING ZHILEHUO CO., LTD., Beijing (CN)

(72) Inventor: Jing TIAN, Beijing (CN)

(73) Assignee: BEIJING ZHILEHUO CO., LTD., Beijing (CN)

(21) Appl. No.: 17/831,409

(22) Filed: Jun. 2, 2022

Related U.S. Application Data
(63) Continuation of application No. PCT/CN2021/074396, filed on Jan. 29, 2021.

(30) Foreign Application Priority Data
Dec. 4, 2019 (CN) 201911229084.5

(51) Int. Cl. G06F 16/9535; G06F 16/9035; G06F 16/908

(52) U.S. Cl. CPC G06F 16/9535; G06F 16/9035; G06F 16/908

(57) ABSTRACT

A method is provided for recommending independent reading for a child. The method may include: obtaining the vocabulary level of the child; determining and pushing articles based on the vocabulary level of the child; checking the vocabulary level of the child in the process of article reading; updating and pushing new articles based on the check result(s) of the vocabulary level for the child. The method adopted by the present disclosure can not only improve the matching and degree of relevance of the recommended article with the vocabulary level of the corresponding child and ensure the child's ability to read recommended articles independently, but also make the child learn and understand new characters independently in the process of independent reading by controlling the recognition rate of recommended articles, thus truly realizing the vocabulary learning in the process of independent reading.

### CROSS-REFERENCE TO RELATED APPLICATIONS

This application is a continuation application of PCT Application No. PCT/CN2021/074396 filed on Jan. 29, 2021, which claims priority to Chinese Patent Application No. 201911229084.5 filed on Dec. 4, 2019, the entire disclosures thereof are incorporated herein by reference for all purposes.

### TECHNICAL FIELD

The present disclosure relates to the technical field of reading education for children, particularly to a method, client device and server for recommending independent reading (reading independently without supervision of adults) for a child.

### BACKGROUND

Reading is a basic ability. Vocabulary and reading are the foundation of learning in all subjects. Therefore, it is very important for children to develop proper reading habits to improve their reading ability.

At present, the most common way to develop children's reading ability is that parents read to children a large number of picture books by reading aloud or reading while pointing to a sentence. In such case, parents, as reading assistants to children, can improve children's reading ability to a certain extent, but cannot effectively improve children's vocabulary level. In addition, because parents do know children's vocabulary level accurately in real time, it is difficult for them to provide children with accurate picture books in line with their vocabulary level.

Thus, it is difficult to determine appropriate picture books for children when their vocabulary level cannot be effectively improved. And the lack of appropriate picture books further affects the improvement of children's vocabulary level, forming a vicious circle, and making it impossible to improve children's independent reading ability.

Therefore, how to recommend books suitable for independent reading for each child and effectively improve their vocabulary level are the technical problems to be solved by the present disclosure.

### SUMMARY

In order to recommend books suitable for independent reading for each child and effectively improve their vocabulary level, the present disclosure discloses a method, a device and a server for recommending independent reading (reading independently without supervision of adults) for a child, comprising: obtaining the vocabulary level of the child; determining and pushing articles from a receiving unit of the client device for receiving articles sent by a sending module of the server based on the vocabulary level of the child; obtaining the vocabulary level of the child comprising: obtaining the set of high-frequency characters that fits the vocabulary level of the child; according to the order of the characters in the set of high-frequency characters, testing the vocabulary level of the child accordingly to obtain the characters that the child knows to form a character set to be taken as the vocabulary level of the child based on the order of the characters in the set of high-frequency characters; and in the process of obtaining the vocabulary level of the child, updating the order of the characters in the set of high-frequency characters according to the child's actual knowledge to the characters in the set of high-frequency characters, and thus forming an adjusted set of high-frequency characters to be taken as the subsequent set of high-frequency characters for testing the vocabulary level of subsequent children (who will take tests in the future). The client device further comprises a sending unit for sending requests for articles to the server. The server further comprises: a processing module, for obtaining articles; and a sending module, for sending articles to the client device.

### BRIEF DESCRIPTION OF THE DRAWINGS

FIG. 1 is a flow diagram of the method for recommending independent reading for a child according to an embodiment of the present disclosure;

FIG. 2 is a flow diagram of obtaining the vocabulary level of a child according to an embodiment of the present disclosure;

FIG. 3 is a flow diagram of determining articles based on the vocabulary level of a child according to an embodiment of the present disclosure;

FIG. 4 is a flow diagram of checking vocabulary level of a child in the process of article reading according to an embodiment of the present disclosure;

FIG. 5 is a flow diagram of reviewing according to an embodiment of the present disclosure;

FIG. 6 is a schematic diagram of the client device for a child's independent reading according to an embodiment of the present disclosure;

FIG. 7 is a schematic diagram of the server for a child's independent reading according to an embodiment of the present disclosure.

### DETAILED DESCRIPTION

The technical scheme of the present disclosure is further described in detail in combination with the drawings and embodiments.

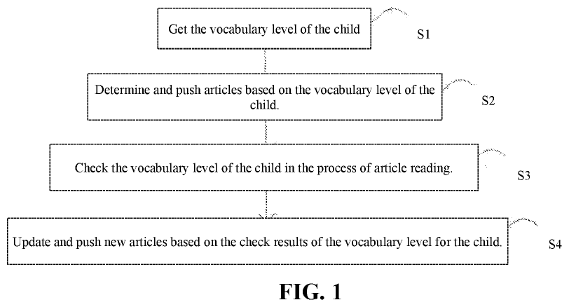

FIG. 1 is a flow diagram of the recommended method for recommending independent reading (reading independently without supervision of adults) for a child according to an embodiment of the present disclosure. As shown in FIG. 1, the recommended method comprises:

S1, obtaining the vocabulary level of the child.

By counting and filtering the number of characters in a large number of children's books, S1 generates a set of high-frequency characters suitable for children's reading, such as a set of 1,000, 500 or other number of high-frequency characters, as the vocabulary level of children.

Wherein, in the process of obtaining the set of high-frequency characters, the set of high-frequency characters can be obtained through classification in advance based on the age of children, that is, the number of characters in books for different ages can be counted to obtain the set of high-frequency characters corresponding to different ages, and then the corresponding set of high-frequency characters can be obtained based on the age of a child who is reading, so that the vocabulary level of the child thus obtained is consistent with the vocabulary of children at the corresponding age.

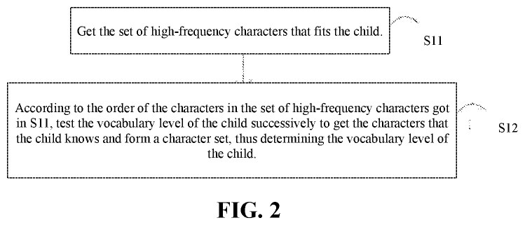

FIG. 2 is a flow diagram of obtaining the vocabulary level of the child according to an embodiment of the present disclosure. As shown in FIG. 2, obtaining the vocabulary level of the child in the embodiment particularly comprises:

S11, obtaining the set of high-frequency characters that fits the child.

In the embodiment, the number of characters in a large number of books suitable for children's reading can be counted in advance, thus obtaining the set of high-frequency characters suitable for the child.

S12, based on the order of the characters in the set of high-frequency characters got in S11, testing the vocabulary level of the child in sequence to get the characters that the child knows to form a character set, and thus determining the vocabulary level of the child.

At the same time, readjusting the order of the characters in the set of high-frequency characters in a reverse direction according to the child's actual vocabulary level of characters in the set of high-frequency characters, thus forming a new set of high-frequency characters and taking it as the subsequent set of high-frequency characters for testing the vocabulary level of subsequent children.

For example, if the set of high-frequency characters is “ABCDEFG”, and the child knows “A”, “C” and “D” after the testing of vocabulary level. The vocabulary level of the characters is “ACD” and the new set of high-frequency characters after adjustment is “ACDBEFG”.

S2, determining and pushing articles based on the vocabulary level of the child.

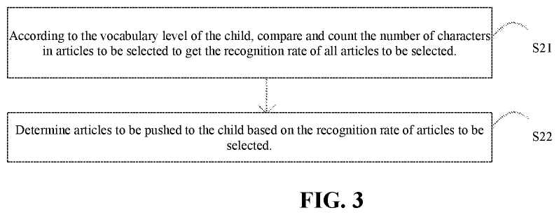

FIG. 3 is a flow diagram of determining articles based on vocabulary level of a child according to an embodiment of the present disclosure. As shown in FIG. 3, in the embodiment, the process of determining articles based on vocabulary level of a child comprises:

S21, comparing and counting the number of characters in articles to be selected to get a recognition rate of all articles to be selected. Wherein, the recognition rate of articles to be selected can be determined based on a numerical relationship or correlation of characters that the child knows and does not know in the articles to be selected.

In the embodiment, the articles to be selected can be obtained through public network resources in advance. Alternatively, an article library can be built according to a custom rule. For example, according to the number of characters in an article, articles containing different number of characters can be generated. For articles containing fewer characters, drawings can be designed to facilitate the child's independent reading and learning.

S22, determining articles to be pushed to the child based on the recognition rate of articles to be selected.

At this point, articles can be selected based on a preset recognition rate, such as 70% or 80%, so as to control the numerical relationship/correlation of characters that the child knows and does not know in the articles pushed to them, and to ensure that the child can read the articles independently and can learn new vocabulary. Similarly, based on different capabilities of learning and reading of different children, the recognition rate of selected articles can be adjusted, so as to control the numerical relationship/correlation of characters that a child knows and does not know in articles pushed to him/her and to help the child learn vocabulary in the process of independent reading.

In addition, if multiple articles are obtained based on the recognition rate, the articles can be readjusted by ordering or screening according to the number of characters not recognized in the articles, and can be recommended to control the number of characters not recognized in the recommended articles.

Optionally, in the embodiment, the process of obtaining the recognition rate of articles to be selected comprises deduplicating the same character and keeping the same character with different pronunciations. Deduplicating the same character refers to deduplication of the same character that appears repeatedly in an article; keeping the same character with different pronunciations refers to counting a same character with different pronunciations in an article based on the pronunciation. In such way, it can not only improve the accuracy of the recognition rate of articles obtained to ensure the high degree of relevance between the pushed articles and the vocabulary level of a child, but also provide pronunciation recognition learning for the child to improve the effect of their vocabulary in view of the situation that the same Chinese character has multiple pronunciations.

In the embodiment, through determination and recommendation of articles based on the vocabulary level of the child, the vocabulary level of the child can be directly correlated with articles, so that articles suitable for independent reading can be accurately recommended to the child. Further, by judging the child's vocabulary of characters in the set of high-frequency characters, the characters that the child particularly knows can be obtained accurately, the vocabulary level of the child can thus be determined, and articles can be determined to further improve the high degree of relevance between the recommended articles and the vocabulary level of the child.

S3, checking the vocabulary level of a child in the process of article reading.

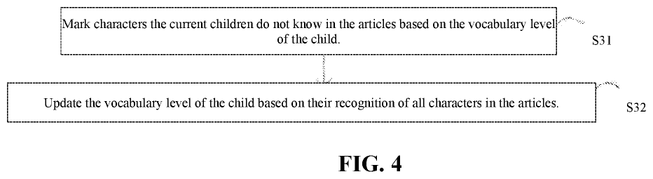

FIG. 4 is a flow diagram of checking the vocabulary level of a child in the process of article reading according to an embodiment of the present disclosure. As shown in FIG. 4, in the embodiment, the process of checking the vocabulary level of the child in the process of article reading particularly comprises:

S31, marking characters the child does not know in the articles based on the vocabulary level of the child. For example, by bolding or coloring the characters, the characters that the child knows and does not know in the articles can be clearly distinguished. Similarly, the characters the child knows in the articles can be marked to make a clear distinction between the characters that the child knows and does not know in the articles. In such way, the child can be guided to click and learn the characters he/she does not know, thus improving the effect of his/her vocabulary.

S32, updating the vocabulary level of a child based on his/her recognition of all characters in the articles. For example, in the process of reading an article by using a touch screen terminal, if a child clicks on a character in the article, the terminal considers that the child does not know the character, so that the recognition of the character can be adjusted; on the contrary, in the process of reading the article, if the child does not click a character in an article, the terminal considers that the child knows the character, so that the recognition of the character can be adjusted. The recognition of a character can not only be directly switched between status of recognized and not recognized, but also be adjusted for many times gradually through classification in percentage (degrees of a child being familiar with different characters).

After the corresponding article is pushed based on the vocabulary level of the child, in the process of reading, the recognition of characters in the article can be checked again according to the vocabulary level of the child. In such way, it can not only get real-time feedback on the change in the vocabulary level of the child and adjust and update the vocabulary level of the child in a timely manner to ensure the accuracy of subsequently selected and pushed articles, but also proofread and give feedback on the accuracy and degree of relevance of the current pushed articles and judge the status of the child's independent reading of the articles, so as to improve the accuracy and high degree of relevance of subsequent article selection based on the vocabulary level to ensure the effect of the child's vocabulary.

In addition, in other embodiments, other methods can be used to check the vocabulary level of the child in the process of article reading. For example, after a child finish reading articles, the characters in the articles can be mixed with interfering characters to guide the child to recognize the characters appearing in the articles by voice and check the vocabulary level of the child.

S4, updating and pushing new articles based on the check result(s) of the vocabulary level for a child.

After the first article is pushed to a child and the vocabulary level of the child is updated in the process of reading, new articles can be selected and pushed according to the updated vocabulary level of the child, so as to push articles to the child in line with his/her latest vocabulary level.

In the method for recommending independent reading for a child, after obtaining the vocabulary level of the child in advance, that is, accurately obtaining the child's understanding of specific characters, articles to be pushed can be selected and determined based on the vocabulary level. Moreover, checking the vocabulary level of the child in the process of article reading can generate a real-time feedback on the change in the vocabulary level of the child. In such way, it can not only greatly improve the matching and degree of relevance of the recommended article with the vocabulary level of the corresponding child and ensure the child's ability to read the recommended article independently, but also timely adjust and update the vocabulary level of the child to improve the accuracy of subsequently selected and pushed articles to ensure efficient vocabulary learning in the process of independent reading.

At the same time, obtaining the recognition rate of articles to be selected based on the vocabulary level of a child and then accurately controlling the number of characters that the child knows and does not know in the articles pushed to him/her can make the child learn and understand new characters (characters not recognized) in the process of independent reading, and truly realize vocabulary learning in the process of independent reading.

Optionally, in the embodiment, through testing the vocabulary level in S12, the set of high-frequency characters can be updated in a reverse direction based on the vocabulary level of the child. The order of the characters in the set of high-frequency characters can be adjusted according to the vocabulary level of the child, so as to get the adjusted set of high-frequency characters and take it as the subsequent set of high-frequency characters for testing the vocabulary level of subsequent children. In such way, by updating the set of high-frequency characters for testing the vocabulary level of the child, the set of high-frequency characters simply got from the statistics of a large number of books can be updated gradually, so that more accurate vocabulary level of the child can be quickly obtained.

In addition, in the process of testing the vocabulary level of a child, the recognition of subsequent characters can be predicted based on the child's recognition of the first some characters of the set of high-frequency characters, so as to improve the efficiency of obtaining the vocabulary level of the child.

Further, the age of a child can be obtained before obtaining the vocabulary level of the child, and the adjusted set of high-frequency characters can be saved by classifying the age of the child as a label after obtaining the vocabulary level of the child. In such way, when obtaining the subsequent set of high-frequency characters, the set of high-frequency characters saved by classification for corresponding age can be obtained based on the age of the child, so as to improve the speed and accuracy of obtaining the set of high-frequency characters for the child, and make it matches and fits the vocabulary level of the child.

In addition, in the process of obtaining the vocabulary level of the child, the time of testing the vocabulary level of the child can be counted, so as to get the vocabulary recognition speed of the child. At this point, in the subsequent selection of articles according to the vocabulary level of the child, the vocabulary recognition speed of the child can be used to control the number of characters in articles to be selected. In such way, the time for the child to finish reading an article can be predicted and controlled to ensure that the child can finish reading the article effectively and improve the effectiveness of the child's independent reading.

Similarly, in the process of reading multiple articles pushed for the first time, the time for a child to read different articles can be counted separately, so as to judge the child's speed of reading different types and contents of articles, and then to predict the child's interest in reading different types and contents of articles. In such way, in the subsequent selection and pushing of articles, the corresponding types and contents of articles can be pushed first, so as to improve the child's interest in independent reading.

As shown in FIG. 1, in the embodiment, after verifying the vocabulary level of the child in the process of article reading, the process further comprises checking the checked characters.

Wherein, checked characters refer to the characters clicked by a child in the process of article reading. The checked characters can be mixed with interfering characters to guide the child to find the checked characters by voice and verify the change of the vocabulary level of the child based on the finding result(s) by the child. Wherein, the interfering characters must have different pronunciations from the checked characters to avoid errors in verification. In such way, the number of a child's misoperation of marked characters in the process of article reading article can be reduced and the accuracy of updating the vocabulary level of a child can be improved.

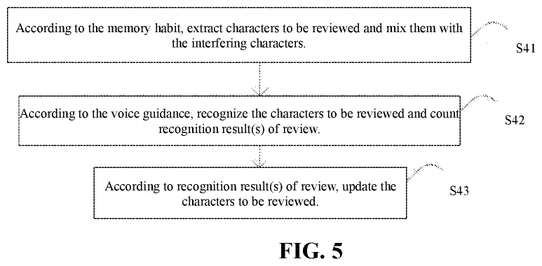

FIG. 5 is a flow diagram of reviewing according to an embodiment of the present disclosure. As shown in FIG. 1 and FIG. 5, the method for recommending independent reading for a child also comprises steps of review (offer a child a review session to go over and further familiarize the characters). By reviewing the characters, a child knows, the effectiveness of the child's vocabulary by independent reading can be improved. Reviewing particularly comprises:

S41, according to the child's memory habit, extracting characters to be reviewed and mixing them with interfering characters.

Wherein, the rule of Ebbinghaus Forgetting Curve can be directly used as the memory habit, or a corresponding memory habit based on memory tests taken by a child in advance can be used. According to the memory habit, the characters recognized by the child, particularly new characters learned through independent reading, can be selected and classified, and mixed with interfering characters. For example, according to Ebbinghaus Forgetting Curve, X, Y and Z that the child learned 20 minutes ago can be selected and randomly mixed with A, B, C and D to form a mixture of the characters to be reviewed and the interfering characters.

S42, according to the voice guidance, recognizing the characters to be reviewed and counting review recognition result(s).

Guiding the child to recognize and click X, Y and Z by voice in a randomly mixed set of A, B, C, D, X, Y and Z. The child's recognition result(s) can be counted. For example, X and Z are recognized, while Y is not recognized.

S43, according to the review recognition result(s), updating the characters to be reviewed and the vocabulary level of the child.

According to the child's accurate recognition of X and Z and his/her wrong recognition of Y, the reviewing position of Y in Ebbinghaus Forgetting Curve can be adjusted, that is, the corresponding position of the character to be reviewed in Ebbinghaus Forgetting Curve can be adjusted. For example, by shortening the time interval for reviewing Y again correctly according to Ebbinghaus Forgetting Curve, or by adjusting the child's Ebbinghaus Forgetting Curve as a whole, such as shortening the reviewing time as a whole to reduce the time interval of reviewing, the effectiveness of the child's reviewing can be ensured and the effect of the child's vocabulary can be improved in independent reading.

At the same time, the vocabulary level of the child can be adjusted based on the review result(s). In such way, when recommending subsequent articles according to the vocabulary level, the characters to be reviewed can be adjusted into the articles to help the child relearn the characters to be reviewed to further improve the effect of vocabulary.

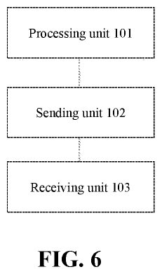

FIG. 6 is a schematic diagram of a client device for a child's independent reading according to an embodiment of the present disclosure. The client device comprises: receiving unit 101, for receiving articles sent by the server; sending unit 103, for sending requests for articles to the server. Wherein, the server determines and sends articles based on the vocabulary level of a child.

Optionally, receiving unit 101 is also for receiving the set of high-frequency characters sent by the server; processing unit 102 is also for testing the vocabulary level of the child based on the set of high-frequency characters; sending unit 103 is also for sending requests for the set of high-frequency characters and result(s) of testing the vocabulary level to the server.

When a child reads independently through the client device, based on the set of high-frequency characters sent by the server, the data of vocabulary level can be obtained through a vocabulary test regarding a set of high-frequency characters. After the data of vocabulary level of the child is obtained, articles pushed by the server according to the data of the vocabulary level of the child can be received, so that the pushed articles can adapt to the vocabulary level of the child. At the same time, in the process of article reading, the recognition of characters in articles can be checked, and articles pushed by the server based on the latest vocabulary level can be received, so that the pushed articles are always relevant to the vocabulary level of the child to improve the child's ability to read independently.

Optionally, processing unit 102 is also for counting the time of testing the vocabulary level of the child based on the set of high-frequency characters; sending unit 103 is also for sending the time of testing the vocabulary level based on the set of high-frequency characters to the server.

At this point, the server can get the vocabulary recognition speed of a child according to the time of testing the vocabulary level of the child based on the set of high-frequency characters, so as to control the number of characters in the selected article, and then control the length of a whole article and push the article with the optimum length to the child. In such way, the child can effectively complete the independent reading of the pushed article, and the effectiveness of the child's independent reading can be improved.

Optionally, when a child read articles with the help of the client device, processing unit 102 is for checking the vocabulary level in the process of article reading; sending unit 103 is for sending data of recognizing checked characters to the server. In addition, after a child finishes reading pushed articles with the help of the client device, receiving unit 101 is also for receiving checked characters and interfering characters sent by the server; processing unit 102 is also for counting result(s) of recognizing checked characters; sending unit 103 is also for sending the result(s) data of children recognizing checked characters to the server. Wherein, checked characters refer to the characters clicked by the child in the process of article reading.

At this point, after the checked characters and the interfering characters sent by the server are received, the child will learn and click the checked characters in the client device under the vocal guidance of checked characters, and the result(s) (data) of recognizing checked characters is sent to the server. The server can accurately update the vocabulary level of the child, thus ensuring the accuracy of subsequently pushed articles.

Optionally, receiving unit 101 is for receiving the characters to be reviewed and interfering characters sent by the server; processing unit 102 is for counting a child's review result(s); sending unit 103 is for sending the child's review result(s) to the server. Wherein, characters to be reviewed refer to the characters that should be reviewed according to the memory habit among the characters the child knows.

After the characters to be reviewed and the interfering characters sent by the server according to the memory habit are received, the characters to be reviewed and the interfering characters are presented at the same time, and the review result(s) of reviewing characters of the child is counted and then sent to the server, the server can adjust the vocabulary level of the child and the memory habit based on the result(s) data of review, and then provide a more accurate subsequent reviewing plan for the child to improve the effect of vocabulary by independent reading.

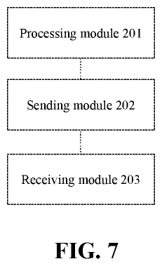

FIG. 7 is a schematic diagram of the server for a child's independent reading according to an embodiment of the present disclosure. The server comprises: receiving module 201, for receiving requests for articles sent by the client device; processing module 202, for obtaining articles; sending module 203, for recommending articles to the client device. Wherein, the server gets and recommends articles based on the vocabulary level of the child.

Optionally, receiving module 201 is also for receiving requests for the set of high-frequency characters and result(s) of testing the vocabulary level that are sent by the client device; processing module 202 is also for obtaining the set of high-frequency characters and the articles based on the result(s) of testing the vocabulary level; sending module 203 is also for sending the set of high-frequency characters to the client device.

When a child read independently with the server, based on the requests for the set of high-frequency characters sent by the server, the set of high-frequency characters is sent to the client device to get the vocabulary level of the child based on the result(s) of testing the vocabulary level sent by the client device, thus determining and pushing articles based on the vocabulary level of the child and making the pushed articles adapt to the vocabulary level of the child. At the same time, after independent article reading, data of recognizing checked characters sent by the client device can be received to update the vocabulary level of the child and the pushed articles, so that the pushed articles can be always relevant to the vocabulary level of the child and the child's ability to read independently can be improved.

Optionally, receiving module 201 is also for receiving the time of testing the vocabulary level of the child based on the set of high-frequency characters that is sent by the client device; processing module 202 is also for obtaining the vocabulary recognition speed of the child and determining the number of characters in the articles.

At this point, the server can get the vocabulary recognition speed of the child according to the time of testing the vocabulary level of the child based on the set of high-frequency characters, so as to control the number of characters in the selected article, and then control the length of the whole article and push the article with the optimum length to the child. In such way, the child can effectively complete the independent reading of the pushed article, and the effectiveness of the child's independent reading can be improved.

Optionally, receiving module 201 is also for receiving data of recognizing checked characters sent by the client device; processing module 202 is also for adjusting the vocabulary level of the child based on the data of recognizing checked characters.

Further, receiving module 201 is also for receiving the requests for recognizing the checked characters and recognition result(s) sent by the client device; processing module 202 is also for obtaining the checked characters and the interfering characters based on the data of recognizing checked characters; sending module 203 is also for sending the checked characters and the interfering characters to the client device. Wherein, checked characters refer to the characters clicked by the child in the data of recognizing checked characters.

At this point, through the requests for recognizing the checked characters sent by the client device are received, the corresponding checked characters and interfering characters are sent to the client device for the child to recognize the checked characters, the vocabulary level of the child can be accurately updated based on the received data of recognized checked characters, thus ensuring the accuracy of subsequently pushed articles.

Optionally, receiving module 201 is for receiving review result(s) by the client device; processing module 202 is for obtaining and updating the characters to be reviewed, and updating the memory habit of a child; sending module 203 is for sending characters to be reviewed and interfering characters to the client device based on the memory habit of a child.

Optionally, the method comprises obtaining the age of the child before obtaining the vocabulary level of the child; saving the adjusted set of high-frequency characters by classifying the age of the child as a label; obtaining the adjusted set of high-frequency characters based on the age of subsequent children.

Optionally, the process of determining articles comprises: according to the vocabulary level of the child, comparing and counting the characters in articles to be selected to get a recognition rate of all articles to be selected based on the vocabulary level of the child; determining articles to be pushed to the child based on the recognition rate of articles to be selected.

Further optionally, the process of obtaining the recognition rate of articles to be selected comprises: deduplicating the same character refers to a deduplication of a character that appears repeatedly in an article; keeping the same character with different pronunciations, that is, counting a same character with different pronunciations in an article based on the pronunciation.

Optionally, after determining articles to be pushed to the child based on the recognition rate of articles to be selected, the method further comprises: updating the articles to be selected based on the number of characters that the child does not recognize in the articles, thus controlling the number of characters that the child does not recognize in the recommended articles.

Optionally, counting the time of testing the vocabulary level of the child to get the recognition speed of the child in the process of obtaining the vocabulary level of the child; determining the number of characters in articles to be selected based on the recognition speed of the child in the process of determining articles based on the vocabulary level of the child.

Optionally, the method further comprises: checking the vocabulary level of the child in the process of article reading; updating and pushing new articles based on the check result(s) of vocabulary level for the child.

Further optionally, checking the vocabulary level of the child in the process of article reading comprises: after the child finishes reading, mixing the characters in the articles with interfering characters, and guiding the child to the vocabulary level check after the child finishes reading; updating the vocabulary level of the child based on the check result(s) of the child.

Optionally, vocabulary level check in the process of article reading comprises: counting the number of characters not recognized by and clicked by the child in the process of reading; updating the vocabulary level of the child based on characters clicked by the child in the articles.

Optionally, marking characters that the child does not recognize in the articles based on the vocabulary level of the child in the process of determining articles, and guiding the child to click the marked characters in the process of article reading.

Optionally, the method further comprises verifying checked characters after checking the vocabulary level of the child in the process of article reading; wherein the checked characters refer to the characters clicked by the child in the process of article reading; mixing the checked characters with interfering characters, guiding the child to find the checked characters by voice, and determining the check result(s) of the vocabulary level of the child based on the result(s) of finding the checked characters.

Optionally, the method further comprises steps of review (offer a child a review session to go over and further familiarize the characters): extracting characters to be reviewed and mixing them with interfering characters according to the child's memory habit; recognizing the characters to be reviewed and counting the recognition result(s) of the review according to a voice guidance; updating the characters to be reviewed and the vocabulary level of the child according to the recognition result(s) of the review; wherein characters to be reviewed refer to the characters recognized by the child as determined based on the vocabulary level of the child. Further optionally, updating the memory habit of the child based on the recognition result(s) of review.

Optionally, the client device further comprises: a receiving unit, for receiving the set of high-frequency characters sent by the server; a processing unit, for testing the vocabulary level of the child based on the set of high-frequency characters; a sending unit, for sending requests for the set of high-frequency characters and result(s) of testing the vocabulary level to the server.

The client device further comprises: a processing unit, for counting the time of testing the vocabulary level of the child based on the set of high-frequency characters; a Sending unit, for sending the time of testing the vocabulary level based on the set of high-frequency characters to the server.

Optionally, the client device further comprises: a processing unit, for checking the vocabulary level in the process of article reading; a sending unit, for sending the data of recognizing checked characters to the server.

Optionally, the client device further comprises: a receiving unit, for receiving the checked characters and the interfering characters sent by the server; a processing unit, for counting recognition result(s) of recognizing checked characters; a sending unit, for sending the result(s) of recognizing checked characters to the server; wherein, the checked characters refer to the characters clicked by the child in the process of article reading.

Optionally, the client device further comprises: a receiving unit, for receiving the characters to be reviewed and the interfering characters sent by the server; a processing unit, for counting result(s) for review; a sending unit, for sending the result(s) for review to the server; wherein, the characters to be reviewed refer to the characters that should be reviewed.

Optionally, the server further comprises: a receiving module, for receiving requests for the set of high-frequency characters and result(s) of testing the vocabulary level that are sent by the client device; a processing module, for obtaining a child's set of high-frequency characters and the articles based on the result(s) of testing the vocabulary level; a sending module, for sending the set of high-frequency characters to the client device.

Optionally, the server further comprises: a receiving module, for receiving the time of testing the vocabulary level of the child based on the set of high-frequency characters sent by the client device; a processing module for obtaining a recognition speed of the child and determining the number of characters in the articles.

Optionally, the server further comprises: a receiving module, for receiving data of recognizing checked characters sent by the client device; a processing module, for adjusting the vocabulary level of children based on the data of recognized checked characters.

Optionally, the server further comprises: a receiving module for receiving the requests for recognizing the checked characters and recognition result(s) sent by the client; a processing module for obtaining the checked characters and the interfering characters based on the data of recognizing checked characters; a sending module for sending the checked characters and the interfering characters to the client; wherein, the checked characters refer to the characters that is clicked by the child and that is in the data of recognizing checked characters.

Optionally, the server further comprises: a receiving module for receiving review result(s) sent by the client; a processing module for obtaining and updating the characters to be reviewed, updating the vocabulary level of the child, and updating the memory habit of the child; a sending module for sending the characters to be reviewed and the interfering characters to the client based on the memory habit of the child; wherein the characters to be reviewed refer to the characters that should be reviewed.

The present disclosure adopts the method of obtaining the vocabulary level of a particular child in advance, that is, accurately obtaining the particular child's understanding of specific characters, and then selecting and determining articles to be pushed based on the vocabulary level of the particular child, accurately controlling the number relationship of characters that the particular child knows and does not know in the articles pushed to the child, and updating the vocabulary level of the particular child in the process of independent reading in real time, thus accurately selecting and determining subsequent articles to be pushed. In such way, it can not only improve and ensure the matching and high degree of relevance of the recommended article with the vocabulary level of the corresponding child and ensure the child's ability to read the recommended article independently, but also make the child learn and understand new characters independently in the process of independent reading by further controlling the recognition rate of the recommended article, thus truly realizing the vocabulary learning in the process of independent reading.

The characters to be reviewed and the interfering characters are sent to the client device according to the memory habit, and data of review result(s) sent by the client device is received, the vocabulary level and the memory habit can be adjusted, and then a more accurate subsequent reviewing plan can be provided for the child based on the vocabulary level of the child and the memory habit to improve the effect of vocabulary by independent reading.

What is claimed is:

1. A method for recommending independent reading for a child, comprising:
obtaining vocabulary level of the child;
determining and pushing articles based on the vocabulary level of the child;
wherein obtaining the vocabulary level of the child comprises:
obtaining a set of high-frequency characters that fits the vocabulary level of the child;
testing the vocabulary level of the child accordingly to obtain the characters that the child knows to form a character set to be taken as the vocabulary level of the child based on the order of the characters in the set of high-frequency characters; and
in the process of obtaining the vocabulary level of the child, updating the order of the characters in the set of high-frequency characters according to the child's actual knowledge to the characters in the set of high-frequency characters, and thus forming an adjusted set of high-frequency characters to be taken as a subsequent set of high-frequency characters for testing the vocabulary level of a subsequent child.

2. The method according to claim 1 further comprising:
obtaining age of the child before obtaining the vocabulary level of the child;
saving the adjusted set of high-frequency characters by classifying the age of the child as a label; and
obtaining the adjusted set of high-frequency characters based on age of subsequent child.

3. The method according to claim 1, wherein determining articles comprises:
comparing and counting the characters in articles to be selected to get a recognition rate of all articles to be selected based on the vocabulary level of the child; and
determining articles to be pushed to the child based on the recognition rate of articles to be selected.

4. The method according to claim 3, wherein obtaining the recognition rate of articles to be selected comprises:
deduplicating the same character refers to a deduplication of a character that appears repeatedly in an article; and
counting a same character with different pronunciations in an article based on the pronunciation.

5. The method according to claim 3, wherein after determining articles to be pushed to the child based on the recognition rate of articles to be selected, the method further comprises: updating the articles to be selected based on the number of characters that the child does not recognize in the articles, thus controlling the number of characters that the child does not recognize in the recommended articles.

6. The method according to claim 1, further comprising:
counting a time of testing the vocabulary level of the child to get the recognition speed of the child in the process of obtaining the vocabulary level of the child; and
determining a number of characters in articles to be selected based on the recognition speed of the child in the process of determining articles based on the vocabulary level of the child.

7. The method according to claim 1 further comprising:
checking the vocabulary level of the child in the process of article reading;
updating and pushing new articles based on the check result(s) of the vocabulary level of the child.

8. The method according to claim 7, wherein checking the vocabulary level of the child in the process of article reading comprises:
mixing the characters in the articles with interfering characters, and guiding the child to the vocabulary level check after the child finishes reading; and
updating the vocabulary level of the child based on the check result(s) of the child.

9. The method according to claim 7, wherein checking the vocabulary level in the process of article reading comprises:
counting the number of characters not recognized by and clicked by the child in the process of reading; and
updating the vocabulary level of the child based on characters clicked by the child in the articles.

10. The method according to claim 9, wherein marking characters that the child does not recognize in the articles based on the vocabulary level of the child in the process of determining articles, and guiding the child to click the marked characters in the process of article reading.

11. The method according to claim 9, further comprising:
verifying checked characters after checking the vocabulary level of the child in the process of article reading; wherein the checked characters refer to the characters clicked by the child in the process of article reading; and
mixing the checked characters with interfering characters, guiding the child to find the checked characters by voice, and determining the check result(s) of the vocabulary level of the child based on the result(s) of finding the checked characters.

12. The method according to claim 1, further comprising:
extracting characters to be reviewed and mixing them with interfering characters according to the child's memory habit;
recognizing the characters to be reviewed and counting the recognition result(s) of the review according to a voice guidance; and
updating the characters to be reviewed and the vocabulary level of the child according to the recognition result(s) of the review;
wherein characters to be reviewed refer to the characters recognized by the child as determined based on the vocabulary level of the child.

13. The method according to claim 12, wherein updating the memory habit of the child based on the recognition result(s) of review.

14. A client device for a child's independent reading, comprising:
a receiving unit for receiving articles sent by a server;
a sending unit for sending requests of articles to the server.

15. The client device according to claim 14, further comprising:
a receiving unit for receiving a set of high-frequency characters sent by the server;
a processing unit for testing a vocabulary level of the child based on the set of high-frequency characters; and
a sending unit for sending requests of the set of high-frequency characters and result(s) of the vocabulary level to the server.

16. The client device according to claim 15, further comprises:
a processing unit for counting the time of testing the vocabulary level of the child based on the set of high-frequency characters;
a sending unit for sending the time of testing the vocabulary level based on the set of high-frequency characters to the server.

17. The client device according to claim 14 further comprising:
a processing unit for checking the vocabulary level in the process of article reading; and
a sending unit for sending data of recognizing checked characters to the server.

18. The client device according to claim 17 further comprising:
a receiving unit for receiving the checked characters and interfering characters sent by the server;
a processing unit for counting recognition result(s) of recognizing checked characters;
a sending unit for sending the recognition result(s) of recognizing checked characters to the server; and
wherein, the checked characters refer to the characters clicked by the child in the process of reading articles.

19. The client device according to claim 14 further comprising:
a receiving unit for receiving the characters to be reviewed and the interfering characters sent by the server;
a processing unit for counting the result(s) of review;
a sending unit for sending the result(s) of review to the server; and
wherein, the characters to be reviewed refer to the characters that should be reviewed.

20. A server for a child's independent reading comprises:
a receiving module for receiving requests of articles sent by the client device;
a processing module for obtaining articles; and
a sending module for sending articles to the client device.

21. The server according to claim 20 further comprising:
a receiving module for receiving requests of the set of high-frequency characters and result(s) of testing a vocabulary level that are sent by the client device;
a processing module, for obtaining a child's set of high-frequency characters and the articles based on the result(s) of testing the vocabulary level; and
a sending module for sending the set of high-frequency characters to the client device.

22. The server according to claim 21 further comprising:
A receiving module for receiving the time of testing the vocabulary level of the child based on the set of high-frequency characters sent by the client device; and
a processing module for obtaining a recognition speed of the child and determining the number of characters in the articles.

23. The server according to claim 20 further comprising:
a receiving module for receiving data of recognizing checked characters sent by the client device; and
a processing module for adjusting the vocabulary level of children based on the data of recognized checked characters.

24. The server according to claim 22 further comprising:
a receiving module for receiving the requests for recognizing the checked characters and recognition result(s) sent by the client device;
a processing module for obtaining the checked characters and the interfering characters based on the data of recognizing checked characters; and
a sending module for sending the checked characters and the interfering characters to the client device;
wherein the checked characters refer to the characters that is clicked by the child and that is in the data of recognizing checked characters.

25. The server according to claim 20 further comprising:
a receiving module for receiving review result(s) sent by the client device;
a processing module for obtaining and updating the characters to be reviewed, updating the vocabulary level of the child, and updating the memory habit of the child; and
a sending module for sending the characters to be reviewed and the interfering characters to the client device based on the memory habit of the child;
wherein the characters to be reviewed refer to the characters that should be reviewed.
